(19) United States
(12) Patent Application Publication
(10) Pub. No.: US 2012/0118976 A1
(43) Pub. Date: May 17, 2012

(54) Personal Universal Receipt Storage Electronic (P.U.R.S.E. for short)

(76) Inventor: Stefan Jerzy Debski, Willington, CT (US)

(21) Appl. No.: 12/946,861

(22) Filed: Nov. 16, 2010

(51) Int. Cl. G06K 19/067

(52) U.S. Cl. 235/492

(57) ABSTRACT

P.U.R.S.E. is the idea of a keychain attachable, small device that electronically stores and wirelessly transmits sales/returns receipts, coupons, and membership card number information. The wireless transmission of data occurs between P.U.R.S.E. and a merchant's computer receiver. The device is also capable of being plugged into a computer for the purpose of viewing/managing of contents by the owner.

The Personal Universal Receipt Storage Electronic (henceforth P.U.R.S.E.) is a device that electronically stores sales information i.e. receipts, coupons, member identification numbers etc. for any individual. The device will be designed such that it can attach to a keychain. In the next paragraphs the functions of P.U.R.S.E. will be discussed.

P.U.R.S.E. will be able to perform wireless transmittal of information between a merchant's register device and the P.U.R.S.E. device itself. P.U.R.S.E. will use an existing or future technology that will allow for this capability.

P.U.R.S.E. will store any store member information that was previously attained by the merchant through scanning a barcode card, i.e. member number. This will be attained by the merchant upon initial wireless transmittal as described in paragraph [002].

Also upon initial wireless transmittal as described in paragraph [002], P.U.R.S.E. will transmit any coupon codes that are specific to the merchant that may be applicable in the transaction.

Upon transaction completion, P.U.R.S.E. will upload from the merchant's register through wireless transmittal as described in paragraph [002], an electronic copy of the transaction receipt, and any coupon codes granted for future transactions. In this way the paper used to print a receipt/coupon is eliminated, and the patron has a running electronic record of his/her receipts for said specific merchant.

Should an item be returned, P.U.R.S.E. will download to the merchant's register, through wireless transmittal as described in paragraph [002], the electronic copy of the receipt that has the item number in question.

P.U.R.S.E. will also have the capability to be plugged into a computer such that the information stored can be viewed by the owner.

With P.U.R.S.E. plugged into a computer, the owner can select online coupons to be stored on P.U.R.S.E.

The computer software for P.U.R.S.E. will have the capability of making recurring purchases from previous receipts.

### BACKGROUND OF THE INVENTION

P.U.R.S.E. is an invention that applies to any and all industries that require a record of sale (receipt). The problems that P.U.R.S.E. addresses are (but not limited to): the use of paper by businesses for receipts, lost receipts, inability to perform returns due to lost receipts, loss of coupons, loss of membership identification cards, and faulty returns due to receipt fraud.

### BRIEF SUMMARY OF INVENTION

The general idea behind P.U.R.S.E. is to create a single device that stores membership card numbers, store coupons granted by individual stores in correspondence with the store membership card numbers, and receipts in correspondence with the store membership card numbers. In this way a customer has the capability of having all of their membership cards, coupons, and receipts in one place for quick, easy access, and use when in a store. By having all of this information in one place, patrons are more likely to use their membership card numbers due to the fact that it is always on hand and eliminates the need to sort through what would be the old collection of cards. Receipts and coupons would not be lost, and paper would be saved.

### DETAILED DESCRIPTION OF INVENTION

P.U.R.S.E. is the idea of a keychain attachable, small device that electronically stores and wirelessly transmits receipts, coupons, and membership card number information.

By storing receipts and coupons electronically, businesses will no longer have to use paper in order to print the receipts that are stored. This will save paper, and in turn save the businesses the cost of the paper. Also, by having all receipts stored in one place, when a customer wishes to return something, the merchant simply scans the item and then P.U.R.S.E. wirelessly transmits the receipt with the item number. This will reduce the number of fraudulent receipts and returns. By having coupons electronically stored on P.U.R.S.E., when engaged in a transaction, P.U.R.S.E. will wirelessly transmit coupons that pertain to item numbers scanned. In this way customers will reap the benefits of coupons granted by a merchant, and will also reap the benefits of having said coupons on hand.

The form of actions taken in order for P.U.R.S.E. to work properly would be to, place the P.U.R.S.E. device within a radius (to be specified) of the merchant's computer receiver. Upon entering this radius, P.U.R.S.E. will transmit to the merchant's receiver the customer's membership card identification number. If currently not a member of the merchant's system,

P.U.R.S.E. will receive an identification number specific to it from the merchant's receiver. Once this process is complete, the merchant then continues the transaction by scanning each item that is being sold. As each item is scanned, it is listed under that purchase in the P.U.R.S.E. If P.U.R.S.E. detects any coupons for items scanned, it will then transmit the coupon information to the merchant's receiver. Once the merchant is done scanning items, the patron will pay for said items. Once the items are paid for, P.U.R.S.E. records the form of payment, closes the list of items for that singular purchase, and stores any coupons granted from the merchant for future transactions.

Should a patron wish to return an item, the process is very similar. One would need to place P.U.R.S.E. within a radius (to be specified) of the merchant's computer receiver. Upon entering this radius, P.U.R.S.E. will transmit to the merchant's receiver the customer's membership card identification number. The merchant then scans and specifies the item to be returned, once scanned, P.U.R.S.E. provides proof of purchase, purchase date, purchase price, and form of payment for the item number in question. Once this information is transmitted, the merchant then grants a refund. This refund is then recorded in P.U.R.S.E. with a date of return, item returned, return amount, and return form of payment. By having this process, the merchant can be confident that no fraudulent returns have taken place, and the patron will not have to worry about finding old receipts for items they may wish to return.

By allowing P.U.R.S.E. the capability of plugging into a computer, the owner of said P.U.R.S.E. can view all transaction receipts and coupons specific to a visited merchant, and also will have the ability to backup the device by keeping a copy of the information it stores, on the computer. In this way, the owner of the P.U.R.S.E. can tailor their shopping to the coupons that are stored on the device, or simply view/monitor expenditures at certain stores. Also with this ability, the owner will be able to select and store online coupons on P.U.R.S.E. With plugging P.U.R.S.E. into a computer a customer will also be able to allow for recurring purchases from old receipts. This would be done by simply selecting an old receipt, and selecting items to be purchased in the future from that receipt. This newly generated list can then be sent to companies that allow for these services. Once the items are delivered and paid for, P.U.R.S.E. then stores this receipt.

This device is different from any other form of transaction receipt today in that it eliminates the use of paper, the use of separate individual plastic membership identification cards that contain member numbers, and stores all coupons, receipts and membership identification numbers electronically in one convenient device. In this way, anyone who has a P.U.R.S.E. device, has all of their receipts, coupons, and membership identification numbers with them in one keychain sized device.

1. The subject matter that is regarded as the invention known as P.U.R.S.E. is the idea of an electronic storage device that stores and wirelessly transmits user data to a merchant's computer receiver, that also has the capability of being plugged into a computer for the purpose of owner viewing/managing of stored contents. The user data includes but is not limited to: membership identification numbers, sales/returns receipts, and coupons. Other data that may be stored on the device know as P.U.R.S.E. includes but is not limited to: data that can be deduced from the recording/storage of user data, i.e. total number of purchases at a specific store, total spent daily, total spent weekly, total spent monthly, total spent yearly, number of coupons used, amount saved through coupon use, number of times a store is visited, days of the week a store is visited etc.

2. The idea of the capabilities of the software required in the operation of P.U.R.S.E. is regarded in the subject matter of the invention.

3. The idea of having a device with the functions and capabilities of P.U.R.S.E. being designed in such a way to attach to a keychain in a convenient size is regarded as subject matter of the invention.
